(19) United States
(12) Patent Application Publication
(10) Pub. No.: US 2003/0224834 A1
(43) Pub. Date: Dec. 4, 2003

(54) Personal digital assistant with removable cover pack

(76) Inventor: Hsien-Lung Yeh, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/246,984

(22) Filed: Sep. 19, 2002

(30) Foreign Application Priority Data
May 14, 2002 (TW) 91110046

(51) Int. Cl. H04M 1/00

(52) U.S. Cl. 455/572; 455/573

(57) ABSTRACT

A personal digital assistant with removable cover pack. The personal digital assistant comprises a base unit and a cover pack. The cover pack is disposed on the base unit in a removable manner, and includes a battery electrically coupled to the base unit. The battery provides power to the base unit and the cover pack.

### BACKGROUND OF THE INVENTION

1. Field of the Invention

The invention relates to a personal digital assistant; in particular, a personal digital assistant including a separable cover pack with a battery.

2. Description of the Related Art

The popularity and use of Personal Digital Assistants (PDAs) has increased in recent years. A PDA is a lightweight, compact productivity and communications tool that can typically be held in one hand, leaving the other hand free to input data with a pen type stylus or a reduced size keyboard. A PDA provides computing and information storage and retrieval capabilities for personal or business use. Typical uses include schedule and address book storage and retrieval, as well as note-taking functions. In addition, many PDAs are capable of running a variety of application software packages (e.g., calculators, text and/or image editors, etc.).

As shown in FIG. 1a and FIG. 1b respectively, PDAs can be divided into two groups, All-In-One PDA 10, and expandable PDA 20.

The advantage of the PDA 10 is that its volume can be miniaturized to a particular specification. However, since the specification of the PDA is pre-determined, its function can only be expanded via a built-in CF (compact flash) slot or SD (secure digital) slot 11. By inserting a CF card or a SD card into the CF slot or the SD slot 11, the function of the PDA 10 can be expanded. As a result, the PDA 10 can add only one function via the CF slot or the SD slot 11, and its expandability is limited.

The advantage of the PDA 20 is that its expandability is better than that of the PDA 10. The PDA 20 can expand its function via a cover pack 21. When the PDA 20 is combined with different cover packs 21, its expanded function is also different. However, when the cover pack 21 is combined with the PDA 20, it surrounds a body 22 of the PDA 20. Thus, the whole volume of the PDA 20 becomes too large to affect the convenience of the portability.

### SUMMARY OF THE INVENTION

In order to address the disadvantages of the aforementioned personal digital assistant, the invention provides a personal digital assistant including a separable cover pack with a battery.

Another purpose of this invention is to provide a miniaturized PDA with good expandability.

Accordingly, the invention provides a personal digital assistant with removable cover pack. The personal digital assistant comprises a base unit and a cover pack. The cover pack is disposed on the base unit in a changeable manner, and includes a battery electrically coupled to the base unit. The battery provides power to the base unit and the cover pack.

In a preferred embodiment, the cover pack includes a short-range wireless communication (such as Bluetooth) unit, CF slot, WLAN (wireless local area network) unit, GSM/GPRS (group special mobile/general packet radio service) unit, GPS (global positioning system) unit, still camera, video camera, bar code reader, or presentation unit.

In another preferred embodiment, the cover pack includes a foldable antenna.

It is understood that the battery can be a Li-polymer battery or a Li-ion battery, and can be built in the cover pack or disposed in the cover pack in a detachable manner.

In another preferred embodiment, the base unit includes a first connector, and the cover pack includes a second connector connecting with the first connector.

Furthermore, the second connector is a golden finger for transmitting signals between the base unit and the cover pack by high- or low-speed access, and the first connector is a slot for the golden finger.

In another preferred embodiment, the base unit includes a groove for guiding the cover pack to dispose on the base unit.

It is understood that the base unit includes a CPU, a memory, a liquid crystal panel, a touch screen, and a SD slot.

In another preferred embodiment, a surface, abutting the cover pack, of the base unit is of plastic, and a surface, abutting the base unit, of the cover pack is of plastic.

It is understood that the plastic can be thinned, and can include isolation properties.

### BRIEF DESCRIPTION OF THE DRAWINGS

The invention is hereinafter described in detail with reference to the accompanying drawings in which:

FIG. 1a is a schematic view of a conventional All-In-One PDA;

FIG. 1b is a schematic view of a conventional expandable PDA;

FIG. 2a and FIG. 2b are schematic views of a PDA as disclosed in this invention;

FIG. 3 is a front view of the PDA in FIG. 2b;

FIG. 4 is a schematic view of an embodiment of a cover pack as disclosed in this invention; and

FIG. 5 is a partial cross section of the PDA in FIG. 2b.

### DETAILED DESCRIPTION OF THE INVENTION

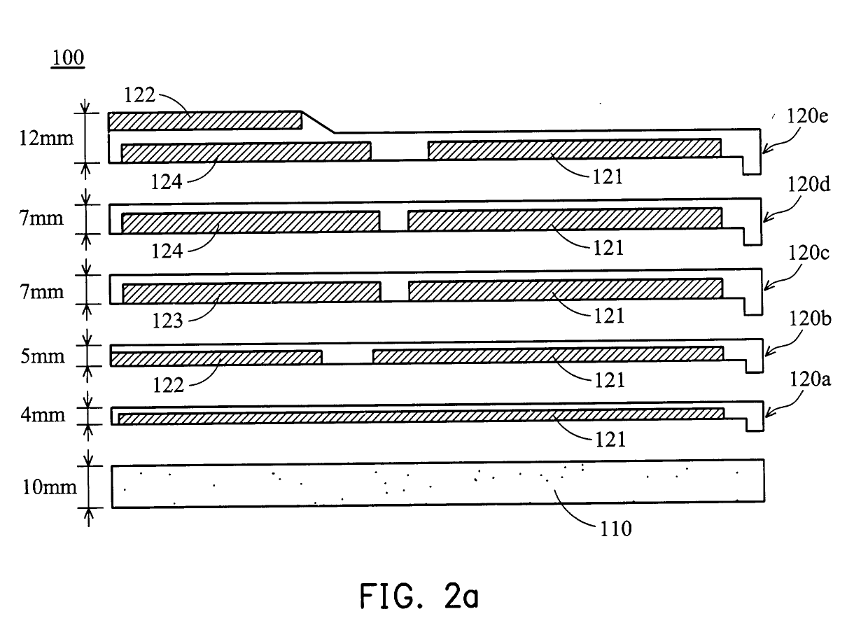

Referring to FIG. 2a and FIG. 2b, a personal digital assistant with removable cover pack (PDA) 100 as disclosed in this invention comprises a base unit 110 and a plurality of cover packs 120a, 120b, 120c, 120d, 120e. It is noted that the base unit 110 is combined with one cover pack 120 at a time as shown in FIG. 2b. Each of the cover packs 120 includes a battery 121 for providing power to the base unit 110. Thus, the PDA 100 can be normally operated when the base unit 110 is combined with the cover pack 120. In addition, based on different requirements, the base unit 110 can be combined with different cover packs 120. By changing the cover pack 120, the function of the PDA 100 can be expanded.

The base unit 110 is used as a body of the PDA 100, and includes basic functions of the PDA 100, such as a CPU, a memory, an output/input interface including a liquid crystal panel and a touch screen, and a SD slot. That is, the PDA 100 includes basic functions no matter which cover pack 120 is combined with the base unit 110. Thus, the thickness of the PDA 100 can be minimized, such as a thickness of 10 mm.

The base unit 110 includes a first connector 111 at one side, and includes two grooves 112, for guiding the cover pack 120 to dispose on the base unit 110, at the corresponding two sides.

The cover packs 120a, 120b, 120c, 120d, 120e are disposed on the base unit 110 in a changeable manner. Every cover pack, such as 120a, 120b, 120c, 120d, 120e, is independent. Each of cover packs 120a, 120b, 120c, 120d, 120e includes a battery 121 electrically coupled to the base unit 110. The battery 121 provides power to the base unit 110 and the cover pack 120.

As shown in FIG. 2a, except the battery 121, each of cover packs 120a, 120b, 120c, 120d, 120e includes other units with the function required by the PDA 100. For example, the cover pack 120a is a cover pack with the battery 121, the cover pack 120b is a cover pack with the battery 121 and a CF slot 122, the cover pack 120c is a cover pack with the battery 121 and a WLAN (IEEE 802. 11a/b) unit 123, the cover pack 120d is a cover pack with the battery 121 and a GSM/GPRS unit 124, the cover pack 120e is a cover pack with the battery 121, the CF slot 122 and the GSM/GPRS unit 124.

It is understood that the type of the cover pack is not limited to the above examples. The cover pack 120 may include a short-range wireless communication (such as Bluetooth) unit, GPS (global positioning system) unit, still camera, video camera, bar code reader, or presentation unit. It is also understood that the cover pack may include one expanded function, such as 120b, 120c, 120d, or include two expanded functions, such as 120e, or includes three or more functions (not shown). Thus, the cover pack can be conveniently designed based on specific requirements.

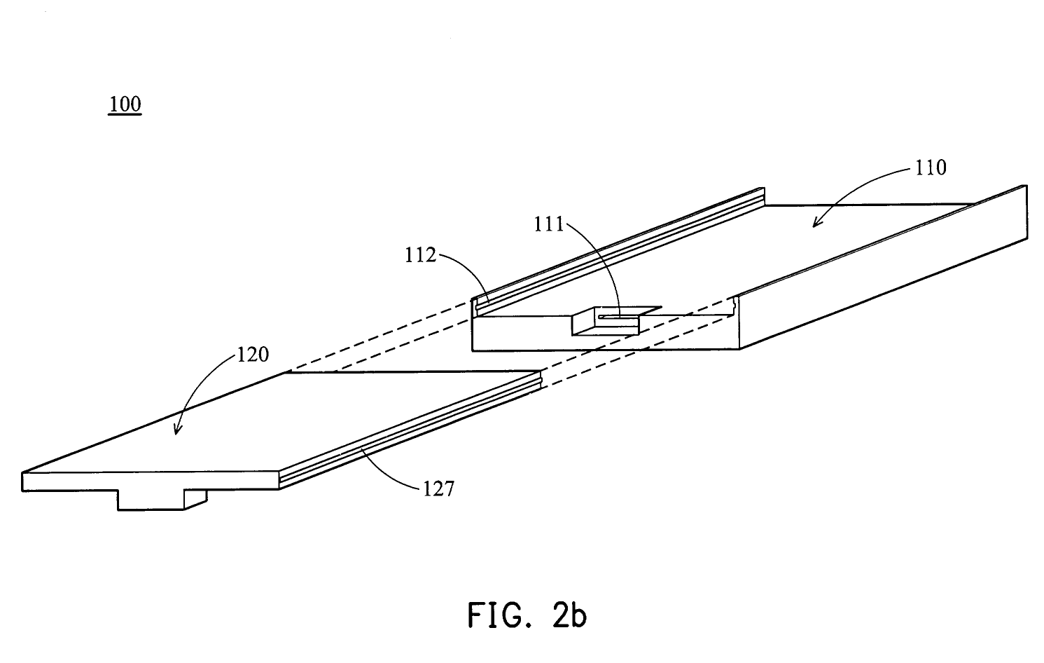

It is noted that the thicknesses of the cover packs 120a, 120b, 120c, 120d, and 120e are different. For example, since the cover pack 120a only includes the battery 121, its thickness is 4 mm. The thickness of the cover pack 120b, including the battery 121 and the CF slot 122, is 5 mm. The thickness of the cover pack 120c, including the battery 121 and the WLAN unit 123, is 7 mm. The thickness of the cover pack 120d, including the battery 121 and the GSM/GPRS unit 124, is 7 mm. The thickness of the cover pack 120e, including the battery 121 and the CF slot 122 and the GSM/GPRS unit 124, is 12 mm. In FIG. 3, the cover pack 120a is shown in solid lines, and the cover pack 120d is shown in dashed lines. Thus, in view of FIG. 3, the whole thickness of the PDA 100 is changed based on different cover packs 120.

In addition, as shown in FIG. 2b, each of the cover packs 120 includes flanges 127, corresponding to the grooves 112 of the base unit 110, at its periphery so that the cover pack 120 can be smoothly disposed on the base unit 110.

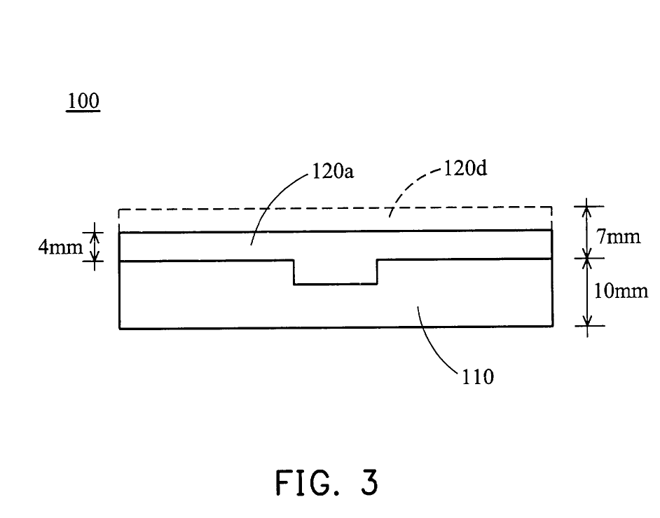

Furthermore, referring to FIG. 4, the cover pack 120 may include an antenna 125 for assisting in signal transmission. The antenna 125 is disposed on the cover pack 120 in a foldable manner.

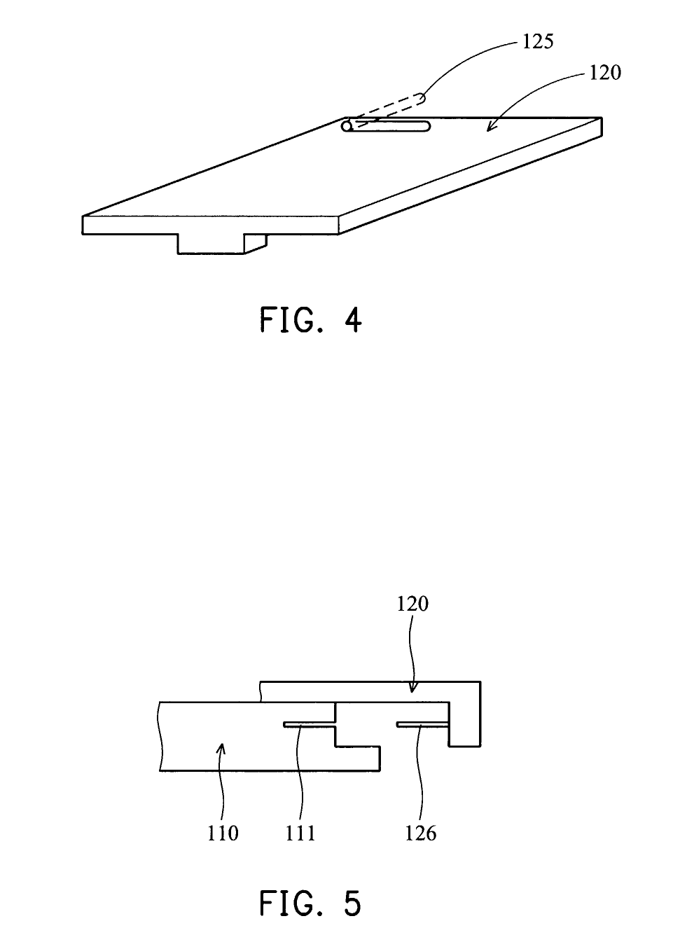

Referring to FIG. 5, each of the cover packs 120 includes a second connector 126 connecting with the first connector 111 of the base unit 110. Thus, when the cover pack 120 is disposed on the base unit 110, it is electrically coupled to the base unit 110 via the first connector 111 and the second connector 126.

Furthermore, the second connector 126 is a golden finger, and the first connector 111 is a slot for the golden finger. The second connector 126 transmits signals between the base unit 110 and the cover pack 120 by high- or low-speed access. Specifically, since the second connector 126 includes a system bus having an address bus and a data bus and a control bus, it can parallelly transmit signals by high-speed access. Thus, the second connector 126 is suitable for connecting the CF slot, the WLAN unit, the still camera, the video camera, the presentation unit and others. In addition, since the second connector 126 can also serially transmit signals, such as RS232, it can transmit signals by low-speed access. Thus, the second connector 126 is also suitable for connecting the Short-range wireless communication unit, the GSM/GPRS unit, the bar code reader, the GPS unit and others. Furthermore, the second connector 126 can transmit signals representing the voltage of the battery 121, the voltage provided by the base unit 110, the gas gauge of the battery 121 and others.

In addition, it is understood that the battery 121 can be a Li-polymer battery or a Li-ion battery, and can be built in the cover pack 120 or disposed in the cover pack 120 in a detachable manner.

Furthermore, a surface, abutting the cover pack 120, of the base unit 110 may be of plastic, and a surface, abutting the base unit 110, of the cover pack 120 maybe of plastic. Since the plastic surfaces are not located at the visible surface of the PDA 100, they may be thinned so as to reduce the thickness of the whole PDA 100. In addition, the plastic surfaces may include isolation properties.

The advantages of the PDA 100 as disclosed in this invention are described as follows with reference to Table 1. In Table 1, “+” means good, “*” means fair, and “−” means bad.

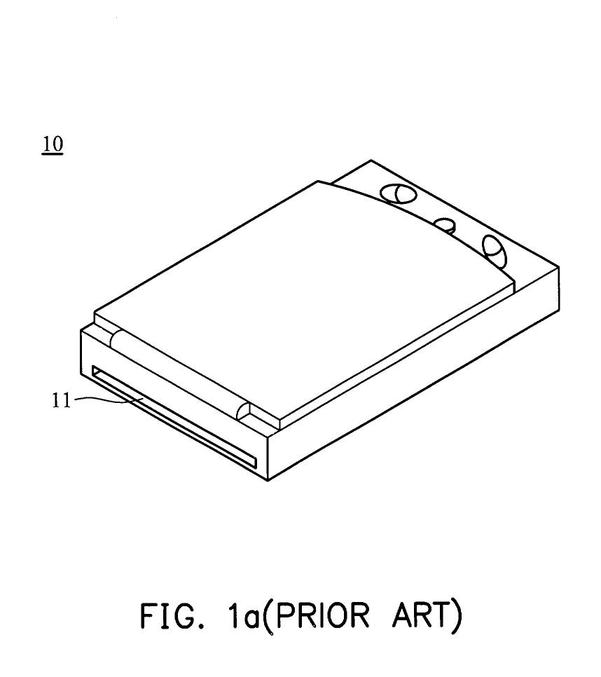

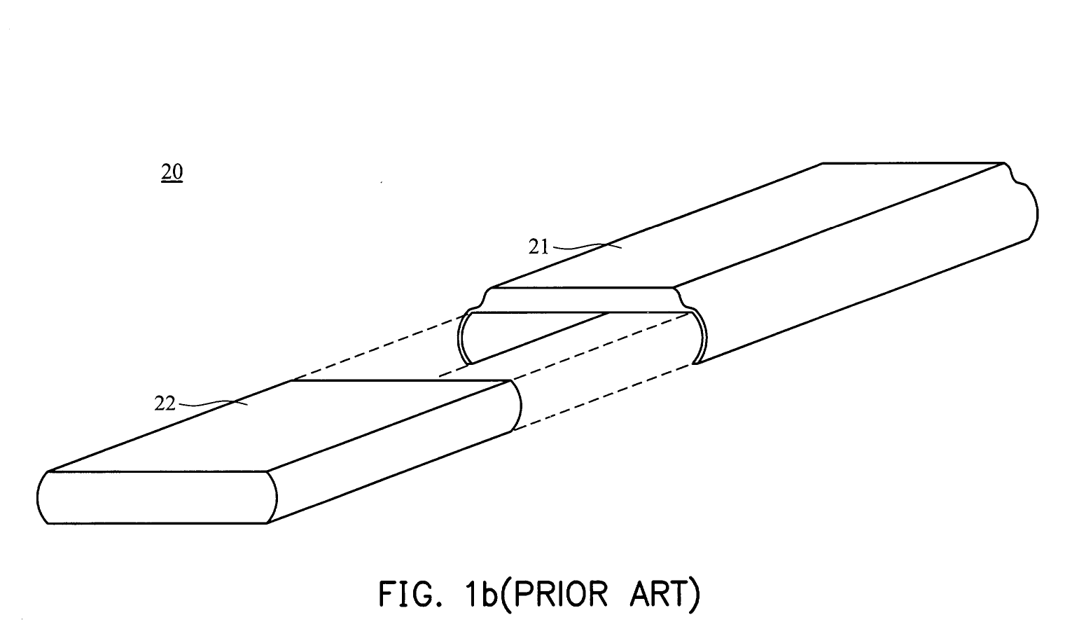

TABLE 1

| | PDA 100 as | All-In-One | Separable |
|---|---|---|---|
| | disclosed in | PDA 10 as | PDA 20 as |
| | this | shown in | shown in |
| | invention | | FIG. 1a |
| Compactness | + | + | − |
| Expandability | + | − | + |
| Use time | + | − | + |
| Thickness | + | + | − |
| Scalability | + | − | * |
| Wireless | + | − | * |
| capability | | | |
| Third party | + | − | + |
| Transferrability | + | + | − |

In Table 1, “Compactness” determines whether the volume of the PDA is properly designed or not. The PDA 100 and the conventional PDA 10 can properly utilize its volume based on needs. However, since the volume of the cover pack 21 and the body 22 of the PDA 20 are pre-set, the volume of the PDA 20 cannot be properly designed.

In Table 1, “expandability” determines whether the function of the PDA can be changed based on the requirement of the user or not. The functions of the PDAs 20, 100 can be expanded via cover packs. However, the PDA 10 can only add one function via the CF slot.

In Table 1, “use time” determines how long the PDA can be used on battery. The PDAs 20, 100 can change specification of the battery so as to extend use time. However, since the PDA 10 is provided with a pre-set battery, its use time is limited.

Under the same conditions, the PDA 100 may be thicker than the PDA 10 by about only 1 mm. However, the PDA 20 with its cover pack 21 is much thicker than the PDA 10, 100.

In Table 1, “scalability” determines whether the current design of the PDA can be maintained or not after the specification of the PDA is changed. When the specification is changed, the whole PDA 10 must be re-designed. In contrast, the PDA 20, 100 can introduce new functions via their cover pack so that the whole PDA need not be re-designed. Furthermore, since the base unit 110 of the PDA 100 only provides basic functions, its scalability is better than the PDA 20.

The PDAs 20, 100 can include wireless communication function via their cover packs, but the PDA 10 cannot. In addition, comparing the PDA 100 with the PDA 20, when the cover pack with the wireless communication function is disposed on the PDA, the PDA 20 is much thicker than the PDA 100.

In Table 1, “third party” determines whether the design of the PDA can be authorized to others to help design or not. The cover pack of the PDAs 20, 100 can be authorized to others to help designing, but the PDA 10 cannot.

In Table 1, “manufacture” determines whether the structure of the PDA can be applied to other devices or not. The structure of the PDA 100 can be applied to the web-pad or tablet PC. The structure of the PDA 10 can also be applied to other devices since it has a predetermined specification. However, the PDA 20 cannot be applied to other devices since its cover pack surrounds the body after assembly.

As stated above, the PDA as disclosed in this invention is provided with good expandability in a miniaturized situation.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A personal digital assistant comprising:
a base unit; and
a cover pack, disposed on the base unit in a changeable manner, including a battery electrically coupled to the base unit so as to provide power to the base unit and the cover pack.

2. The personal digital assistant as claimed in claim 1, wherein the cover pack includes a short-range wireless communication unit.

3. The personal digital assistant as claimed in claim 2, wherein the short-range wireless communication unit comprises Bluetooth protocol technology.

4. The personal digital assistant as claimed in claim 1, wherein the cover pack includes a compact-flash slot.

5. The personal digital assistant as claimed in claim 1, wherein the cover pack includes a wireless local area network unit.

6. The personal digital assistant as claimed in claim 1, wherein the cover pack includes a group special mobile/general packet radio service unit.

7. The personal digital assistant as claimed in claim 1, wherein the cover pack includes a global positioning system unit.

8. The personal digital assistant as claimed in claim 1, wherein the cover pack includes a still camera.

9. The personal digital assistant as claimed in claim 1, wherein the cover pack includes a video camera.

10. The personal digital assistant as claimed in claim 1, wherein the cover pack includes a bar code reader.

11. The personal digital assistant as claimed in claim 1, wherein the cover pack includes an antenna.

12. The personal digital assistant as claimed in claim 11, wherein the antenna is disposed on the cover pack in a foldable manner.

13. The personal digital assistant as claimed in claim 1, wherein the battery is a Li-Polymer battery.

14. The personal digital assistant as claimed in claim 1, wherein the battery is a Li-Ion battery.

15. The personal digital assistant as claimed in claim 1, wherein the base unit includes a first connector, and the cover pack includes a second connector connecting with the first connector.

16. The personal digital assistant as claimed in claim 15, wherein the second connector is a golden finger, and the first connector is a slot for the golden finger.

17. The personal digital assistant as claimed in claim 1, wherein the base unit includes a groove for guiding the cover pack to dispose on the base unit.

18. The personal digital assistant as claimed in claim 1, wherein the base unit includes a CPU, a memory, and an output/input interface.

19. The personal digital assistant as claimed in claim 18, wherein the output/input interface includes a liquid crystal panel and a touch screen.

20. A personal digital assistant comprising:a base unit with a central process unit, a memory, and an output/input interface, and without a battery; and a cover pack, disposed on the base unit in a changeable manner, including at least a battery electrically coupled to the base unit so as to provide power to the base unit and the cover pack.
